(19) United States
(12) Patent Application Publication
(10) Pub. No.: US 2026/0227780 A1
(43) Pub. Date: Aug. 6, 2026

(54) INFORMATION PROCESSING METHOD, PROGRAM, AND MOBILE BODY CONTROL SYSTEM

(71) Applicant: SONY GROUP CORPORATION, Tokyo (JP)

(72) Inventors: Takashi KONNO, Tokyo (JP); Masashi ESHIMA, Tokyo (JP)

(21) Appl. No.: 19/150,971

(22) PCT Filed: Jan. 22, 2024
(86) PCT No.: PCT/JP2024/001638

§ 371 Date: Jul. 25, 2025

(30) Foreign Application Priority Data
Feb. 6, 2023 (JP) 2023-016037

(51) Int. Cl. G05D 1/246; G05B 17/02; G05D 1/242; G05D 1/243

(52) U.S. Cl. CPC G05D 1/246; G05B 17/02; G05D 1/242; G05D 1/2435

(57) ABSTRACT

The present disclosure relates to an information processing method, a program, and a mobile body control system capable of robustly estimating a position and an attitude of a mobile body with respect to an environment. On the basis of structure information of an environment in which a mobile body moves, shape information representing a shape of the environment in the same format as sensor information is acquired, semantic information representing a meaning of each region constituting the environment is extracted from the structure information, the semantic information about the sensor information acquired by sensing the environment during movement of the mobile body is estimated, and matching between the shape information and the sensor information is performed for each attribute on the basis of the semantic information. The present disclosure can be applied to, for example, control of a mobile body inside a building.

### TECHNICAL FIELD

The present disclosure relates to an information processing method, a program, and a mobile body control system, and more particularly, to an information processing method, a program, and a mobile body control system capable of robustly estimating a position and an attitude of a mobile body with respect to an environment.

### BACKGROUND ART

In order for a mobile body such as a robot to autonomously move, a map is generally created in advance by simultaneous localization and mapping (SLAM).

For example, Patent Document 1 discloses a system that acquires an RGB point cloud from a point cloud obtained from light detection and ranging (LiDAR) and an RGB image obtained from an RGB camera, and generates a point cloud map in real time on the basis of feature amounts extracted from the RGB point cloud.

Furthermore, Patent Document 2 discloses a technique for estimating a self-position of a mobile body by matching feature points between camera images obtained from a plurality of cameras and map data stored in advance.

### CITATION LIST

### Patent Document

Patent Document 1: Japanese Translation of PCT International Application Publication No. 2021-515254

Patent Document 2: Japanese Patent Application Laid-Open No. 2021-082181

### SUMMARY OF THE INVENTION

### Problems to be Solved by the Invention

In recent years, use of environmental structure information available in advance, such as building information modeling (BIM) and construction information modeling (CIM), is spreading.

In self-position estimation, it is conceivable to use the above-described structure information as a map. However, since such structure information is information in a format different from that of sensor information acquired by sensing, the structure information cannot be used as it is, and there may be an object not included in the structure information in the actual environment. Therefore, there is a possibility that the accuracy of self-position estimation is reduced due to mismatching or occlusion.

The present disclosure has been made in view of such a situation, and an object thereof is to enable robust estimation of a position and an attitude of a mobile body with respect to an environment.

### Solutions to Problems

An information processing method of the present disclosure is an information processing method including: acquiring, on the basis of structure information of an environment in which a mobile body moves, shape information representing a shape of the environment in the same format as sensor information; extracting, from the structure information, semantic information representing a meaning of each region constituting the environment; estimating the semantic information about the sensor information acquired by sensing the environment during movement of the mobile body; and performing matching between the shape information and the sensor information for each attribute on the basis of the semantic information.

A program of the present disclosure is a program for causing a computer to execute processing of: acquiring, on the basis of structure information of an environment in which a mobile body moves, shape information representing a shape of the environment in the same format as sensor information; extracting, from the structure information, semantic information representing a meaning of each region constituting the environment; estimating the semantic information about the sensor information acquired by sensing the environment during movement of the mobile body; and estimating an absolute position of the mobile body in the environment by performing matching between the shape information and the sensor information for each attribute on the basis of the semantic information.

A mobile body control system of the present disclosure is a mobile body control system including: a shape information acquisition unit that, on the basis of structure information of an environment in which a mobile body moves, acquires shape information representing a shape of the environment in the same format as sensor information;
a semantic information extraction unit that, from the structure information, extracts semantic information representing a meaning of each region constituting the environment;
a semantic information estimation unit that estimates the semantic information about the sensor information acquired by sensing the environment during movement of the mobile body; and
a matching unit that performs matching between the shape information and the sensor information for each attribute on the basis of the semantic information.

In the present disclosure, shape information representing a shape of an environment in the same format as sensor information is acquired on the basis of structure information of the environment in which a mobile body moves, semantic information representing a meaning of each region constituting the environment is extracted from the structure information, the semantic information about the sensor information acquired by sensing the environment during movement of the mobile body is estimated, and matching between the shape information and the sensor information is performed for each attribute on the basis of the semantic information.

### BRIEF DESCRIPTION OF DRAWINGS

FIG. 1 is a diagram illustrating a configuration example of a mobile body control system to which a technology according to the present disclosure is applied.

FIG. 2 is a block diagram illustrating a configuration example of a computer and a mobile body.

FIG. 3 is a flowchart describing self-position estimation processing.

FIG. 4 is a block diagram illustrating a configuration example of a mobile body control system according to a first embodiment.

FIG. 5 is a diagram illustrating a flow of self-position estimation processing according to the first embodiment.

FIG. 6 is a block diagram illustrating a configuration example of a mobile body control system according to a second embodiment.

FIG. 7 is a diagram illustrating a flow of self-position estimation processing according to the second embodiment.

FIG. 8 is a block diagram illustrating a configuration example of a mobile body control system according to a third embodiment.

FIG. 9 is a diagram describing matching between images.

FIG. 10 is a diagram illustrating a flow of self-position estimation processing according to the third embodiment.

FIG. 11 is a block diagram illustrating a configuration example of hardware of a computer.

### MODE FOR CARRYING OUT THE INVENTION

Hereinafter, a mode for carrying out the present disclosure (hereinafter referred to as an embodiment) will be described. Note that the description will be given in the following order.
1. Background and prior art problems
2. Configuration and operation of mobile body control system to which technology according to present disclosure is applied
3. First embodiment (Point cloud matching using BIM and LiDAR)
4. Second embodiment (Point cloud matching using BIM and camera)
5. Third embodiment (Image matching using BIM and camera)
6. Configuration example of hardware of computer

### 1. Background and Prior Art Problems

In order for a mobile body such as a robot to autonomously move, it is common to create a map in advance by simultaneous localization and mapping (SLAM), but there are the following problems. One is that it takes time and effort to create a map, and there is a possibility that creation omission occurs. The other is that an absolute position with respect to the environment cannot be acquired, for example, in the case of moving inside a building.

On the other hand, in recent years, a BIM/CIM that models building information by digital transformation (DX) at a construction site has been standardized.

Building information modeling (BIM) refers to construction of a building information model that includes, in addition to mainly three-dimensional shape information created on a computer, building attribute information (semantic information) such as the name and area of a room and the like, specification and performance of materials and members, and finishing. The model constructed by the BIM is called a BIM model. Furthermore, in addition to the BIM model, the entire information including two-dimensional addition in the BIM is called BIM data or the like.

In self-position estimation, it is conceivable to use, as a map, information (hereinafter, referred to as structure information) regarding a structure of an environment available in advance, such as the BIM model (hereinafter, also simply referred to as BIM) described above.

However, such structure information is information in a format different from that of the sensor information acquired by sensing, and thus cannot be used as it is. For example, since computer-aided design (CAD) data of a building is only an aggregate of mesh data, it cannot be used as a map for self-position estimation as it is.

Moreover, although the structure information includes only information specific to the environment such as a wall or a door, since the actual environment includes various objects including an animal body such as a person, there is a possibility that the accuracy of self-position estimation is reduced due to erroneous matching or occlusion.

Furthermore, since the structure information is created by a human hand, there is a possibility that a difference from an actual environment such as a construction deviation, a difference in texture, and sensor noise occurs.

Therefore, in the technology according to the present disclosure, by filtering an object not included in the structure information, it is possible to prevent a decrease in accuracy of self-position estimation due to erroneous matching or occlusion. Specifically, by using semantic information, matching is performed only for information specific to a building such as a wall, a door, and a window, thereby realizing robust self-position estimation.

Furthermore, in the technology according to the present disclosure, robustness against the difference is improved by absorbing the difference between the prior information and the actual environment. Specifically, by reflecting the matching result as reliability information in the structure information and performing weighting in the estimation of the position and attitude, the accuracy of the self-position estimation is improved.

### 2. Configuration and Operation of Mobile Body Control System to Which Technology According to Present Disclosure is Applied

A configuration and an operation of a mobile body control system to which the technology according to the present disclosure is applied will be described.

### <System Configuration>

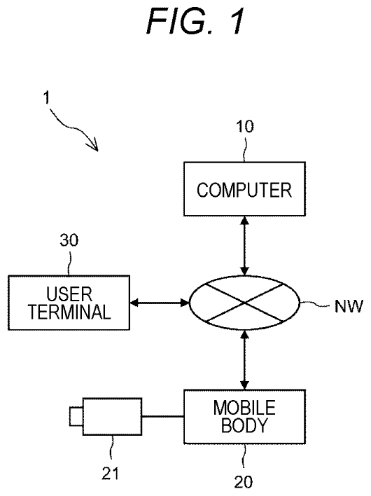

FIG. 1 is a diagram illustrating a configuration example of a mobile body control system to which a technology according to the present disclosure is applied.

A mobile body control system 1 illustrated in FIG. 1 is configured to include a computer 10, a mobile body 20, and a user terminal 30. The computer 10, the mobile body 20, and the user terminal 30 can be connected to each other by wired communication or wireless communication via a network NW. The network NW may be a local area network (LAN), a wide area network (WAN) that connects LANs, or the Internet.

The computer 10 can be configured by an information processing apparatus such as a personal computer (PC), a tablet terminal, or a server on a cloud.

The computer 10 creates and holds a map (pre-map) used for self-position estimation of the mobile body 20 on the basis of structure information of an environment in which the mobile body 20 moves acquired in advance. The pre-map created by the computer 10 is supplied to the mobile body 20 via the network NW when the mobile body 20 autonomously moves.

The mobile body 20 includes a mobile robot that can autonomously travel and move on the ground or the like. The mobile robot may be mainly a guide robot, a cleaning robot, a delivery robot, a vacuum cleaner robot, or the like that travels and moves in a building. Furthermore, the mobile body 20 may be a drone that flies in space or a vehicle capable of automated driving.

The mobile body 20 includes a sensor 21, and performs autonomous movement using a pre-map created by the computer 10 while sensing a surrounding environment by the sensor 21.

The user terminal 30 can include a portable terminal such as a PC, a tablet terminal, or a smartphone used by a user who monitors and controls the movement of the mobile body 20. The user terminal 30 inputs the structure information to the computer 10 or instructs the computer 10 to create the pre-map according to the operation of the user. Furthermore, the user terminal 30 instructs the mobile body 20 to start or end the movement or presents the position information of the mobile body 20 to the user according to the operation of the user.

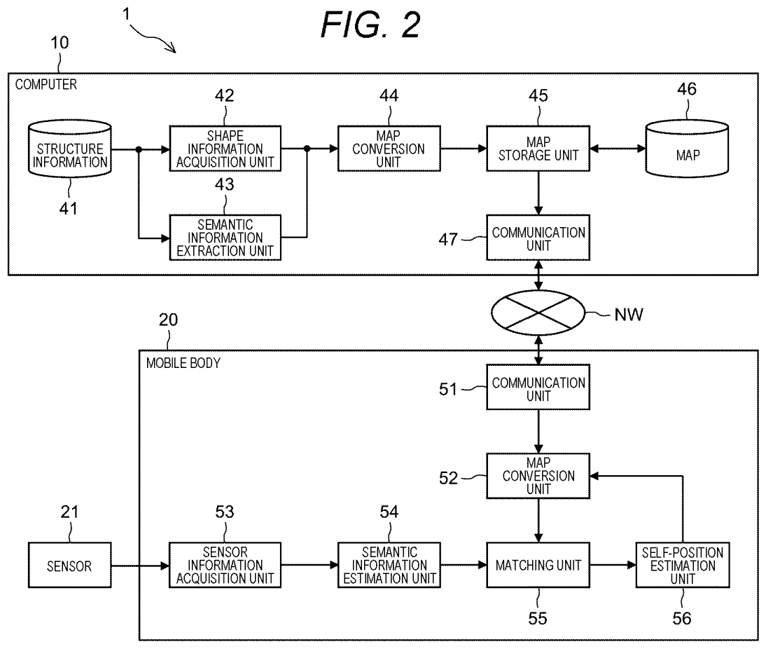

FIG. 2 is a block diagram illustrating a configuration example of the computer 10 and the mobile body 20 in the mobile body control system 1.

As illustrated in FIG. 2, the computer 10 is configured to include a structure information holding unit 41, a shape information acquisition unit 42, a semantic information extraction unit 43, a map conversion unit 44, a map storage unit 45, a map holding unit 46, and a communication unit 47.

The structure information holding unit 41 holds structure information input in advance by the user terminal 30. The structure information may include data in an industry foundation classes (IFC) format such as the BIM model and the CIM model described above, a floor map, a high definition (HD) map (high precision three-dimensional map), and the like. Such structure information includes shape information representing the shape (three-dimensional shape) of the environment in which the mobile body 20 moves and semantic information representing the meaning of each region constituting the environment.

The shape information is information in the same format as the sensor information that can be acquired by the mobile body 20 sensing the environment, and specifically, may take a format such as a point cloud or an image. The semantic information can also be said to be semantic information representing an attribute (also referred to as a label) of each object included in the environment.

The shape information acquisition unit 42 acquires shape information representing the shape of the environment on the basis of the structure information held in the structure information holding unit 41, and supplies the shape information to the map conversion unit 44.

The semantic information extraction unit 43 extracts semantic information of each region constituting the environment from the structure information held in the structure information holding unit 41, and supplies the semantic information to the map conversion unit 44.

The map conversion unit 44 converts the shape information from the shape information acquisition unit 42 into a semantic map using the semantic information from the semantic information extraction unit 43. The semantic map is a pre-map in which semantic information extracted for each region is added to each region constituting the environment of the shape represented by the shape information. The obtained semantic map is held in the map holding unit 46 or read from the map holding unit 46 by the map storage unit 45.

The communication unit 47 transmits and receives various types of information (data) to and from the mobile body 20 by communicating with the mobile body 20 via the network NW. For example, the communication unit 47 transmits the semantic map read by the map storage unit 45 to the mobile body 20 via the network NW.

As illustrated in FIG. 2, the mobile body 20 is configured to include a communication unit 51, a map conversion unit 52, a sensor information acquisition unit 53, a semantic information estimation unit 54, a matching unit 55, and a self-position estimation unit 56. Note that functional blocks of the mobile body 20 illustrated in FIG. 2 represent a functional configuration of a computer (information processing apparatus) mounted on the mobile body 20.

The communication unit 51 communicates with the computer 10 via the network NW to transmit and receive various types of information (data) to and from the computer 10. For example, the communication unit 51 receives the semantic map transmitted from the computer 10 via the network NW, and supplies the semantic map to the map conversion unit 52.

The map conversion unit 52 converts the semantic map from the communication unit 51 into shape information representing the shape of the environment around the self-position on the basis of the current self-position of the mobile body 20, and supplies the shape information to the matching unit 55. Semantic information is added to the converted shape information around the self-position.

The sensor information acquisition unit 53 acquires sensor information obtained by the sensor 21 sensing the environment from the sensor 21 while the mobile body 20 is moving, and supplies the sensor information to the semantic information estimation unit 54. The sensor 21 may include a light detection and ranging (LiDAR), a depth sensor, a camera, or the like. In a case where the sensor 21 includes a LiDAR or a depth sensor, a point cloud is acquired as sensor information. In a case where the sensor 21 includes a camera, an image is acquired as sensor information.

The semantic information estimation unit 54 estimates semantic information about the sensor information from the sensor information acquisition unit 53. Specifically, for each region constituting the environment included in the sensor information from the sensor information acquisition unit 53, the semantic information of each region is estimated using an existing method such as semantic segmentation. The sensor information from which the semantic information has been estimated is supplied to the matching unit 55.

The matching unit 55 performs matching between the shape information from the map conversion unit 52 and the sensor information from the semantic information estimation unit 54 for each attribute represented by the semantic information on the basis of the semantic information. The matching result between the shape information and the sensor information for each attribute is supplied to the self-position estimation unit 56.

The self-position estimation unit 56 estimates the self-position of the mobile body 20 on the basis of the matching result from the matching unit 55. The estimated self-position is used for conversion of the semantic map into shape information around the self-position by the map conversion unit 52.

### (Operation of System)

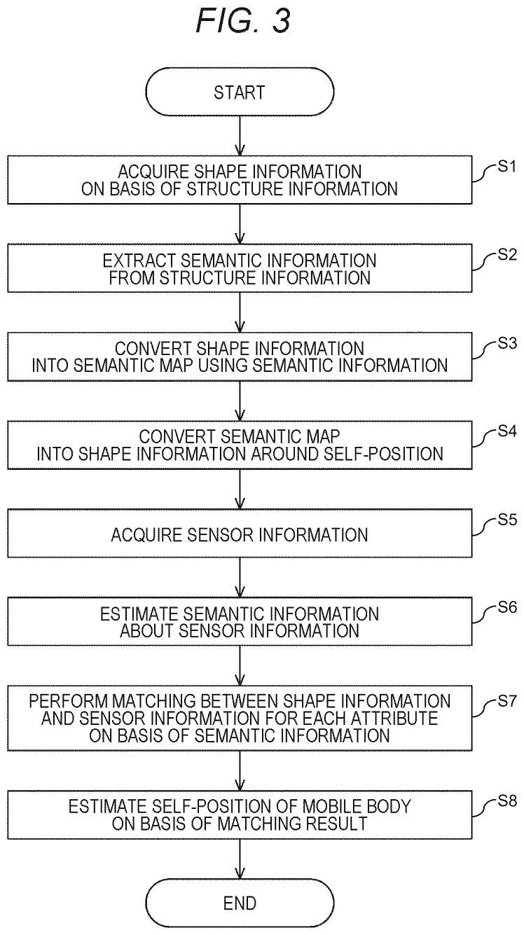

Next, self-position estimation processing of the mobile body 20 in the mobile body control system 1 will be described with reference to a flowchart of FIG. 3.

In step S1, the shape information acquisition unit 42 acquires shape information representing the shape of the environment on the basis of the structure information held in the structure information holding unit 41.

In step S2, the semantic information extraction unit 43 extracts semantic information of each region constituting the environment from the structure information held in the structure information holding unit 41.

In step S3, the map conversion unit 44 converts the shape information acquired by the shape information acquisition unit 42 into a semantic map (pre-map) using the semantic information extracted by the semantic information extraction unit 43, and transmits the semantic map to the mobile body 20.

The creation of the pre-map in steps SI to S3 may be executed in advance before the movement of the mobile body 20 is started, or may be executed in real time during the movement of the mobile body 20. Processing of step S4 is executed when the movement of the mobile body 20 is started.

In step S4, the map conversion unit 52 converts the semantic map (pre-map) transmitted from the computer 10 into shape information around the self-position to which semantic information is added.

In step S5, the sensor information acquisition unit 53 acquires sensor information obtained by sensing the environment from the sensor 21.

In step S6, the semantic information estimation unit 54 estimates semantic information about the sensor information acquired by the sensor information acquisition unit 53.

In step S7, the matching unit 55 performs matching between the shape information converted from the pre-map and the sensor information acquired by sensing for each attribute represented by the semantic information on the basis of the semantic information. At this time, the matching unit 55 performs matching between the shape information and the sensor information only for attributes unique to the structure of the environment, such as a wall, a door, and a window.

In step S8, the self-position estimation unit 56 estimates the self-position of the mobile body 20 on the basis of a matching result between the shape information and the sensor information for each attribute.

According to the above processing, matching between the shape information converted from the pre-map and the sensor information acquired by sensing is performed only for building-specific information such as a wall, a door, and a window by using the semantic information. Therefore, since filtering of an object not included in the structure information is performed, it is possible to prevent a decrease in estimation accuracy of the self-position due to erroneous matching or occlusion, and it is possible to robustly estimate the position and attitude of the mobile body with respect to the environment.

Hereinafter, a specific embodiment of the above-described mobile body control system 1 will be described.

### 3. First Embodiment (Point Cloud Matching Using BIM and LiDAR)

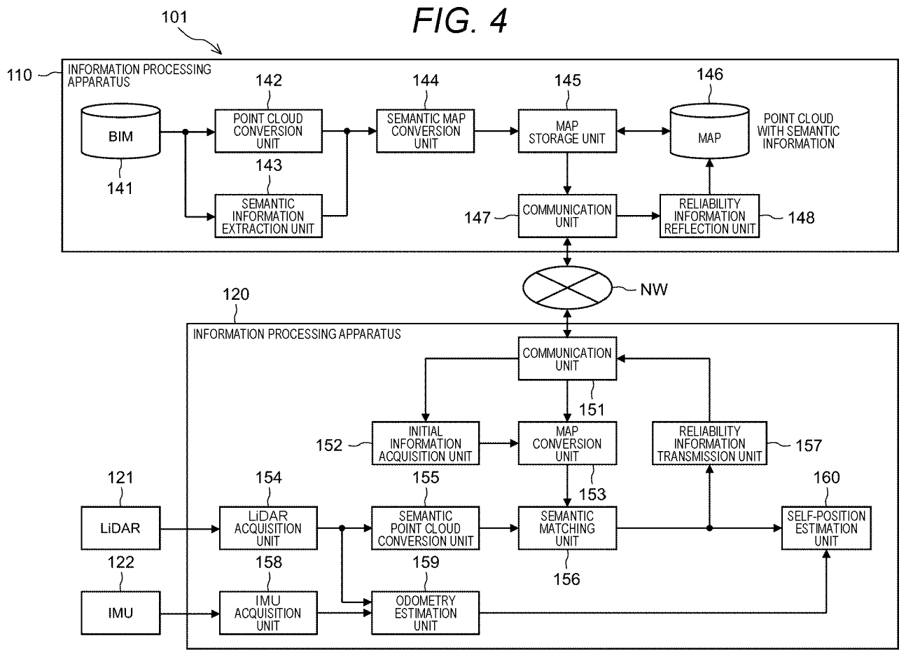

FIG. 4 is a block diagram illustrating a configuration example of a mobile body control system according to a first embodiment of the present disclosure. In the present embodiment, BIM is used as the structure information, and LiDAR is used as the sensor, whereby matching between the point clouds is performed.

A mobile body control system 101 illustrated in FIG. 4 is configured to include an information processing apparatus 110 and an information processing apparatus 120. Note that, in the mobile body control system 101, a user terminal (not illustrated) is assumed to be connected to the network NW in addition to the information processing apparatus 110 and the information processing apparatus 120.

The information processing apparatus 110 and the information processing apparatus 120 illustrated in FIG. 4 correspond to the computer 10 and the mobile body 20 in FIG. 2, respectively.

As illustrated in FIG. 4, the information processing apparatus 110 includes a BIM holding unit 141, a point cloud conversion unit 142, a semantic information extraction unit 143, a semantic map conversion unit 144, a map storage unit 145, a map holding unit 146, a communication unit 147, and a reliability information reflection unit 148.

The BIM holding unit 141 corresponds to the structure information holding unit 41 in FIG. 2. The BIM holding unit 141 holds a BIM model input in advance by the user terminal 30.

The point cloud conversion unit 142 corresponds to the shape information acquisition unit 42 in FIG. 2, converts the BIM model held in the BIM holding unit 141 into a point cloud, and supplies the point cloud to the semantic map conversion unit 144.

The semantic information extraction unit 143 corresponds to the semantic information extraction unit 43 in FIG. 2, extracts semantic information from the BIM model held in the BIM holding unit 141, and supplies the semantic information to the semantic map conversion unit 144.

The semantic map conversion unit 144 corresponds to the map conversion unit 44 in FIG. 2, and converts the point cloud from the point cloud conversion unit 142 into a semantic map (pre-map) using the semantic information from the semantic information extraction unit 143. The obtained semantic map is held in the map holding unit 146 or read from the map holding unit 146 by the map storage unit 145.

The communication unit 147 transmits and receives various types of information (data) to and from the information processing apparatus 120 by communicating with the information processing apparatus 120 via the network NW. For example, the communication unit 147 transmits the semantic map read by the map storage unit 145 to the information processing apparatus 120 via the network NW.

The reliability information reflection unit 148 reflects the matching result obtained from the information processing apparatus 120 as reliability information on the pre-map (point cloud with semantic information) held in the map holding unit 146. Specifically, the reliability information reflection unit 148 weights the point cloud in the matching for each attribute on the basis of the reliability information.

An information processing apparatus 120 illustrated in FIG. 4 corresponds to a computer mounted on the mobile body 20 described above. In addition to the LiDAR 121 corresponding to the above-described sensor 21, an inertial measurement unit (IMU) 122 that detects translational movement and rotational movement of the mobile body 20 is connected to the information processing apparatus 120.

The information processing apparatus 120 illustrated in FIG. 4 includes a communication unit 151, an initial information acquisition unit 152, a map conversion unit 153, a LiDAR acquisition unit 154, a semantic point cloud conversion unit 155, a semantic matching unit 156, a reliability information transmission unit 157, an IMU acquisition unit 158, an odometry estimation unit 159, and a self-position estimation unit 160.

The communication unit 151 transmits and receives various types of information (data) to and from the information processing apparatus 110 by communicating with the information processing apparatus 110 via the network NW. For example, the communication unit 151 receives the semantic map transmitted from the information processing apparatus 110 via the network NW, and supplies the semantic map to the map conversion unit 153.

The initial information acquisition unit 152 acquires an initial position that is a movement start position of the mobile body 20 on which the information processing apparatus 120 is mounted, and supplies the initial position to the map conversion unit 153.

The map conversion unit 153 corresponds to the map conversion unit 52 in FIG. 2, converts the semantic map from the communication unit 151 into a 3D point cloud around the self-position on the basis of the self-position of the mobile body 20, and supplies the 3D point cloud to the semantic matching unit 156.

The LiDAR acquisition unit 154 corresponds to the sensor information acquisition unit 53 in FIG. 2, and acquires a 3D point cloud obtained by the LiDAR 121 while the mobile body 20 is moving, and supplies the 3D point cloud to the semantic point cloud conversion unit 155 and the odometry estimation unit 159.

The semantic point cloud conversion unit 155 corresponds to the semantic information estimation unit 54 in FIG. 2, and estimates semantic information for each point with respect to the 3D point cloud from the LiDAR acquisition unit 154. The 3D point cloud to which the semantic information is added to each point is supplied to the semantic matching unit 156.

The semantic matching unit 156 corresponds to the matching unit 55 in FIG. 2, and performs matching between the 3D point cloud around the self-position from the map conversion unit 153 and the 3D point cloud to which the semantic information from the semantic point cloud conversion unit 155 is added, for each attribute represented by the semantic information, on the basis of the semantic information. The matching result between the point clouds for each attribute is supplied to the reliability information transmission unit 157 and the self-position estimation unit 160.

The reliability information transmission unit 157 transmits the matching result for each attribute from the semantic matching unit 156 to the information processing apparatus 110 via the communication unit 151 as reliability information in matching.

The IMU acquisition unit 158 acquires IMU data representing the moving state and the attitude of the mobile body 20 obtained by the IMU 122 while the mobile body 20 is moving, and supplies the IMU data to the odometry estimation unit 159.

The odometry estimation unit 159 estimates the position and attitude of the mobile body 20 on the basis of the accumulated 3D point cloud from the LiDAR acquisition unit 154 and the IMU data from the IMU acquisition unit 158, and supplies the position and attitude to the self-position estimation unit 160.

The self-position estimation unit 160 estimates the self-position of the mobile body 20 on the basis of the matching result from the semantic matching unit 156. Moreover, the self-position estimation unit 160 outputs the absolute position and attitude of the mobile body 20 with respect to the environment on the basis of the estimated self-position of the mobile body 20 and the position and attitude of the mobile body 20 estimated by the odometry estimation unit 159.

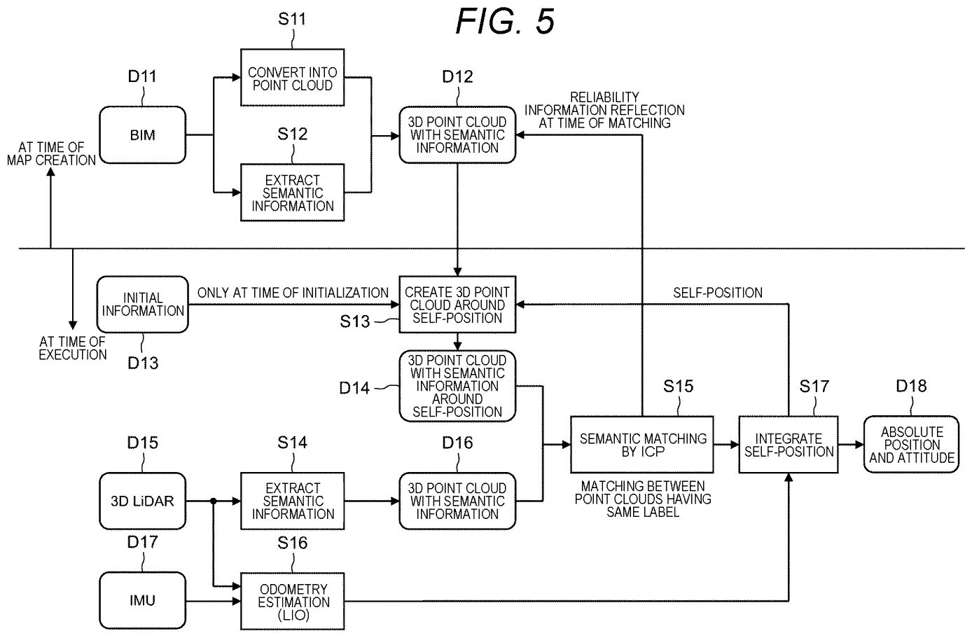

Next, a flow of self-position estimation processing in the mobile body control system 101 of the present embodiment will be described with reference to FIG. 5. The processing of FIG. 5 is divided into processing at the time of creating a map (pre-map) and processing at the time of execution after the start of movement of the mobile body 20.

First, as processing at the time of map creation, in step S11, the information processing apparatus 110 (point cloud conversion unit 142) converts a BIM model D11 into a point cloud by sampling points from the mesh of the BIM model D11 held in the BIM holding unit 141.

Subsequently, in step S12, the information processing apparatus 110 (semantic information extraction unit 143) extracts semantic information (for example, a label representing a window, a wall, a door, or the like) from the BIM model D11 held in the BIM holding unit 141.

As a result, a 3D point cloud D12 with semantic information in which each point holds semantic information is obtained as a pre-map.

Next, as processing at the time of execution, in step S13, the information processing apparatus 120 (map conversion unit 153) creates a 3D point cloud D14 with semantic information around the self-position from the 3D point cloud D12 with semantic information (pre-map). Here, at the time of initialization, the 3D point cloud D14 with semantic information is created using initial information D13 representing the initial position of the mobile body 20, and at times other than the time of initialization, the 3D point cloud D14 with semantic information is created using the self-position estimated by the self-position estimation unit 160.

The initial information D13 representing the initial position of the mobile body 20 may be given by inputting the initial position with respect to the pre-map according to, for example, an operation of the user with respect to a UI or the like on the user terminal.

Moreover, a home base (dock) of the mobile body 20 may be set in the BIM model D11, and the home base may be set as an initial position (movement start position of the mobile body 20). In this case, accurate matching is performed by installing a marker on the home base. The home base may function as a charging dock to which the mobile body 20 returns.

Furthermore, the initial position may be a position fixed every time, such as in front of a door or a window.

Moreover, a function of presenting a candidate location of an initial position may be provided. Specifically, a candidate location of an initial position closest to the search query is presented using an existing image search or point cloud search method. In a case where the presented candidate location is away from the actual initial position, the user may be requested to input by a UI or the like.

Now, returning to the description of FIG. 5, in step S14, the information processing apparatus 120 (semantic point cloud conversion unit 155) extracts semantic information for each point from a 3D LiDAR point cloud D15, thereby outputting a 3D point cloud D16 with semantic information in which each point holds semantic information.

In step S15, the information processing apparatus 120 (semantic matching unit 156) performs matching between point clouds having the same label by iterative closest point (ICP) using semantic information for the 3D point cloud D14 with semantic information and the 3D point cloud D16 with semantic information. At this time, an animal body such as a person is excluded from the matching. As a matching result, a matching score is output for each label. The matching score for each label is reflected (weighted) in the pre-map (3D point cloud D12 with semantic information) as reliability information at the time of matching. Therefore, since matching using the weighted pre-map is performed, it is possible to absorb a difference between the pre-map and the actual environment.

In step S16, the information processing apparatus 120 (odometry estimation unit 159) estimates the position and attitude of the mobile body 20 with respect to consecutive frames using LiDAR inertial odometry (LIO) of an existing method on the basis of the 3D LiDAR point cloud D15 and an IMU data D17.

In step S17, the information processing apparatus 120 (self-position estimation unit 160) estimates the self-position of the mobile body 20 on the basis of the matching score for each label. Furthermore, the information processing apparatus 120 (self-position estimation unit 160) integrates the estimated self-position of the mobile body 20 and the position and attitude of the mobile body 20 obtained by odometry estimation using an existing method such as a Kalman filter, thereby outputting an absolute position and attitude D18 of the mobile body 20 with respect to the BIM coordinate system. Therefore, even in a case where the mobile body 20 moves inside the building, the absolute position with respect to the environment can be acquired.

According to the above processing, since filtering of an animal body such as a person not included in the BIM model D11 is performed, it is possible to prevent a decrease in estimation accuracy of the self-position due to erroneous matching or occlusion. Specifically, by using semantic information, matching of only information specific to a building such as a wall, a door, and a window is performed, so that robust self-position estimation can be performed.

Furthermore, according to the above processing, since the difference between the pre-map and the actual environment is absorbed, robustness against the difference can be improved. Specifically, by reflecting the matching result as the reliability information in the pre-map and performing weighting in the estimation of the position and attitude, it is possible to improve the accuracy of the self-position estimation.

### 4. Second Embodiment (Point Cloud Matching Using BIM and Camera)

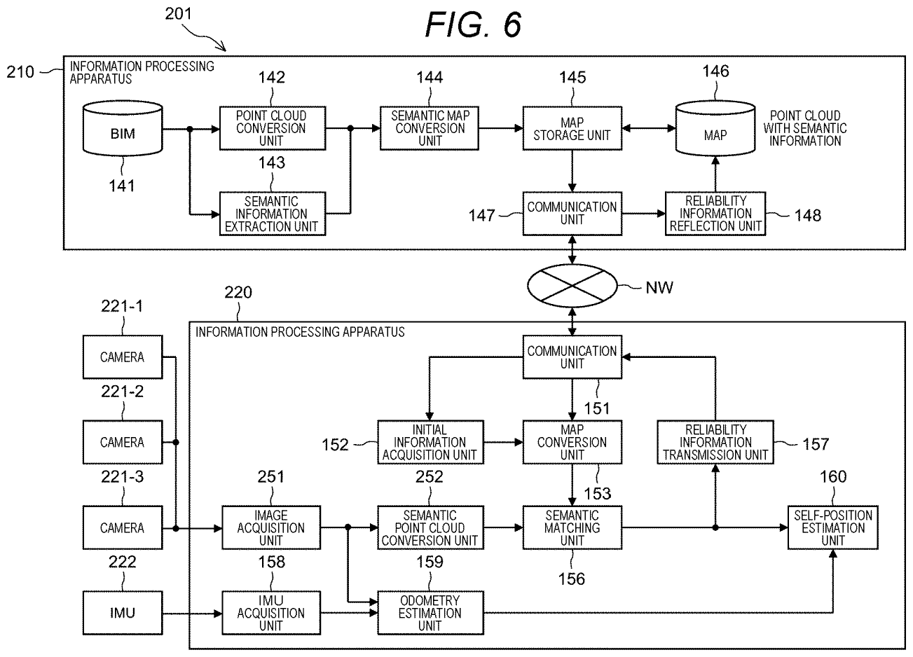

FIG. 6 is a block diagram illustrating a configuration example of a mobile body control system according to a second embodiment of the present disclosure. In the present embodiment, BIM is used as the structure information, and a plurality of cameras (multi-cameras) is used as the sensor, so that matching between the point clouds is performed.

A mobile body control system 201 illustrated in FIG. 6 is configured to include an information processing apparatus 210 and an information processing apparatus 220. Note that, in the mobile body control system 201, a user terminal (not illustrated) is assumed to be connected to the network NW in addition to the information processing apparatus 210 and the information processing apparatus 220.

The information processing apparatus 210 and the information processing apparatus 220 illustrated in FIG. 6 correspond to the computer 10 and the mobile body 20 in FIG. 2, respectively.

Note that, in the mobile body control system 201 in FIG. 6, the same reference signs are given to the configurations similar to the functional blocks included in the mobile body control system 101 in FIG. 4, and the description thereof will be omitted.

An information processing apparatus 210 illustrated in FIG. 6 has a configuration similar to that of the information processing apparatus 110 in the mobile body control system 101 in FIG. 4.

On the other hand, an information processing apparatus 220 illustrated in FIG. 6 is different from the information processing apparatus 120 in the mobile body control system 101 in FIG. 4 in including an image acquisition unit 251 and a semantic point cloud conversion unit 252 instead of the LiDAR acquisition unit 154 and the semantic point cloud conversion unit 155. Furthermore, an IMU 222 is connected to the information processing apparatus 220 in addition to a plurality of (three) cameras 221-1 to 221-3 corresponding to the above-described sensor 21. Note that the number of cameras connected to the information processing apparatus 220 is not limited to three.

The image acquisition unit 251 corresponds to the sensor information acquisition unit 53 in FIG. 2, and acquires a plurality of camera images (multi-camera images) obtained by the plurality of cameras 221-1 to 221-3 during the movement of the mobile body 20, and supplies the acquired images to the semantic point cloud conversion unit 252 and the odometry estimation unit 159.

The semantic point cloud conversion unit 252 corresponds to the semantic information estimation unit 54 in FIG. 2, and converts the plurality of camera images from the image acquisition unit 251 into a bird's eye view (BEV) image of a bird's eye view. Furthermore, the semantic point cloud conversion unit 252 estimates semantic information for each pixel for each of the plurality of camera images from the image acquisition unit 251. Each pixel of the BEV image to which the semantic information is added is converted into a point cloud and supplied to the semantic matching unit 156.

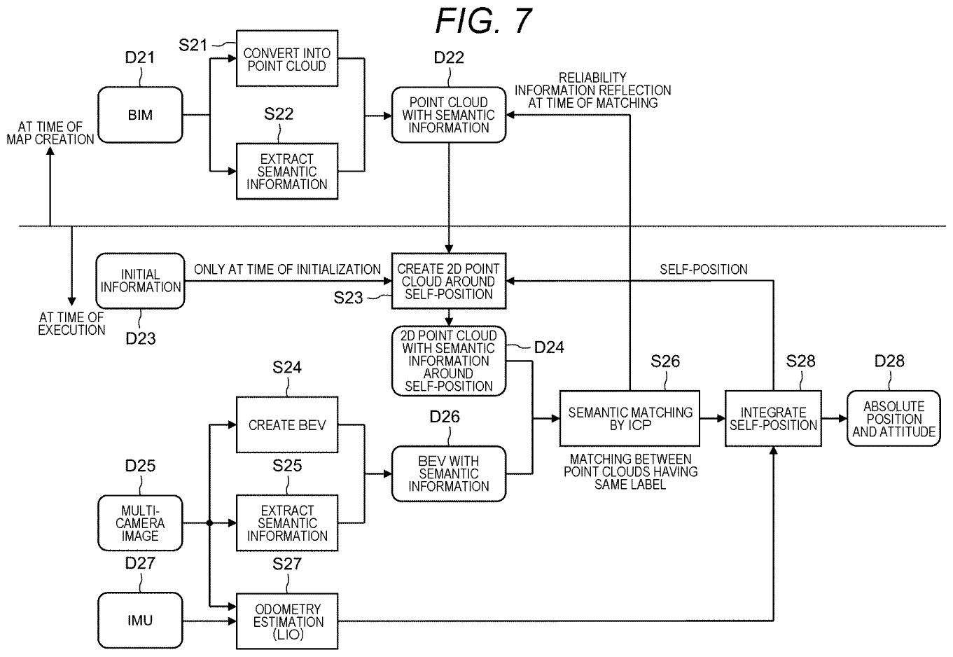

Next, a flow of self-position estimation processing in the mobile body control system 201 of the present embodiment will be described with reference to FIG. 7. Processing of FIG. 7 is divided into processing at the time of creating a map (pre-map) and processing at the time of execution after the mobile body 20 starts to move.

First, as processing at the time of map creation, in step S21, the information processing apparatus 210 (point cloud conversion unit 142) converts a BIM model D21 into a point cloud by sampling points from the mesh of the BIM model D21 held in the BIM holding unit 141.

Subsequently, in step S22, the information processing apparatus 210 (semantic information extraction unit 143) extracts semantic information (for example, a label representing a window, a wall, a door, or the like.) from the BIM model D21 held in the BIM holding unit 141.

As a result, a point cloud D22 with semantic information in which each point holds semantic information is obtained as the pre-map.

Next, as processing at the time of execution, in step S23, the information processing apparatus 220 (map conversion unit 153) creates a 2D point cloud D24 with semantic information around the self-position from the point cloud D22 with semantic information (pre-map). Here, at the time of initialization, the 2D point cloud D24 with semantic information is created using initial information D23 representing the initial position of the mobile body 20, and at times other than the time of initialization, the 2D point cloud D24 with semantic information is created using the self-position estimated by the self-position estimation unit 160.

In step S24, the information processing apparatus 220 (semantic point cloud conversion unit 252) converts a multi-camera image D25 into a BEV image using, for example, an inverse perspective mapping (IPM) of an existing method.

In step S25, the information processing apparatus 220 (semantic point cloud conversion unit 252) extracts semantic information for each pixel from the multi-camera image D25, thereby outputting a BEV image D26 with semantic information in which each pixel holds semantic information.

In step S26, the information processing apparatus 220 (semantic matching unit 156) performs matching between the point clouds of the same label by ICP using semantic information for the 2D point cloud obtained by converting each pixel of the 2D point cloud D24 with semantic information and the BEV image D26 with semantic information. At this time, an animal body such as a person is excluded from the matching. As a matching result, a matching score is output for each label. The matching score for each label is reflected (weighted) in the pre-map (the point cloud D22 with semantic information) as reliability information at the time of matching. Therefore, since matching using the weighted pre-map is performed, it is possible to absorb a difference between the pre-map and the actual environment.

In step S27, the information processing apparatus 220 (odometry estimation unit 159) estimates the position and attitude of the mobile body 20 with respect to consecutive frames using visual inertial odometry (VIO) of an existing method on the basis of the multi-camera image D25 and IMU data D27.

In step S28, the information processing apparatus 220 (self-position estimation unit 160) estimates the self-position of the mobile body 20 on the basis of the matching score for each label. Furthermore, the information processing apparatus 220 (self-position estimation unit 160) integrates the estimated self-position of the mobile body 20 and the position and attitude of the mobile body 20 obtained by odometry estimation using an existing method such as a Kalman filter, thereby outputting an absolute position and attitude D28 of the mobile body 20 with respect to the BIM coordinate system. Therefore, even in a case where the mobile body 20 moves inside the building, the absolute position with respect to the environment can be acquired.

According to the above processing, since filtering of an animal body such as a person not included in the BIM model D21 is performed, it is possible to prevent a decrease in estimation accuracy of the self-position due to erroneous matching or occlusion. Specifically, by using semantic information, matching of only information specific to a building such as a wall, a door, and a window is performed, so that robust self-position estimation can be performed.

Furthermore, according to the above processing, since the difference between the pre-map and the actual environment is absorbed, robustness against the difference can be improved. Specifically, by reflecting the matching result as the reliability information in the pre-map and performing weighting in the estimation of the position and attitude, it is possible to improve the accuracy of the self-position estimation.

### 5. Third Embodiment (Image Matching Using BIM and Camera)

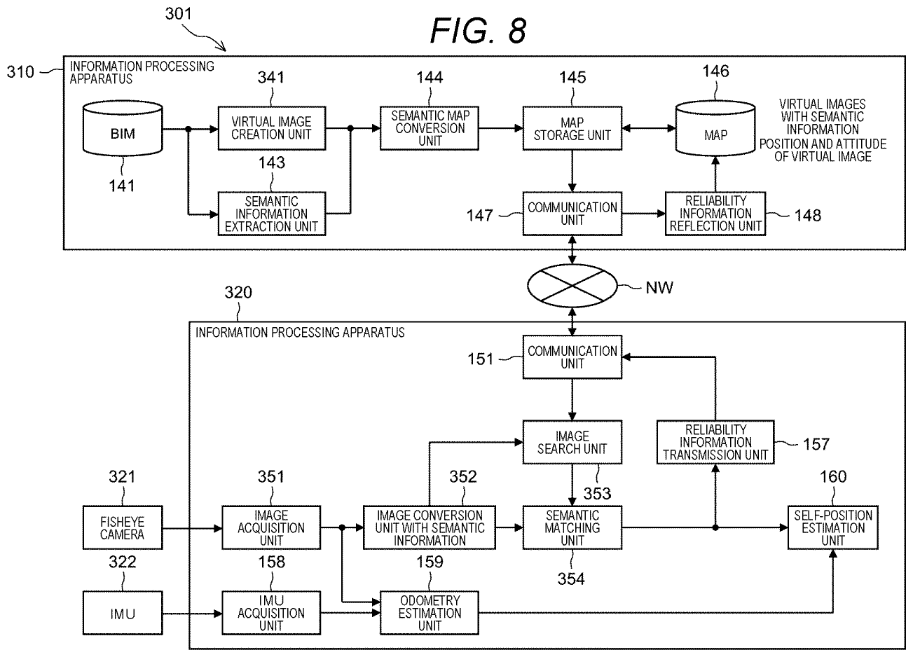

FIG. 8 is a block diagram illustrating a configuration example of a mobile body control system according to a third embodiment of the present disclosure. In the present embodiment, BIM is used as the structure information, and a camera is used as the sensor, whereby matching between images is performed.

A mobile body control system 301 illustrated in FIG. 8 is configured to include an information processing apparatus 310 and an information processing apparatus 320. Note that, in the mobile body control system 301, a user terminal (not illustrated) is assumed to be connected to the network NW in addition to the information processing apparatus 310 and the information processing apparatus 320.

The information processing apparatus 310 and the information processing apparatus 320 illustrated in FIG. 8 correspond to the computer 10 and the mobile body 20 in FIG. 2, respectively.

Note that, in the mobile body control system 301 in FIG. 8, the same reference signs are given to the configurations similar to the functional blocks included in the mobile body control system 101 in FIG. 4, and the description thereof will be omitted.

An information processing apparatus 310 illustrated in FIG. 8 is different from the information processing apparatus 120 in the mobile body control system 101 in FIG. 4 in including a virtual image creation unit 341 instead of the point cloud conversion unit 142.

The virtual image creation unit 341 corresponds to the shape information acquisition unit 42 in FIG. 2, and creates a virtual image of a plurality of viewpoints by rendering images acquired at a plurality of locations (position and attitude) by the virtual camera disposed on the BIM model held in the BIM holding unit 141, and supplies the virtual image to the semantic map conversion unit 144.

In the semantic map conversion unit 144, each of the virtual images from the virtual image creation unit 341 is converted into a semantic map (virtual image with semantic information) using the semantic information from the semantic information extraction unit 143. Each of the obtained virtual images with semantic information is associated with the position and attitude of each of the virtual images (virtual cameras) on the BIM model, and is held in the map holding unit 146 as a pre-map.

On the other hand, an information processing apparatus 320 illustrated in FIG. 8 is different from the information processing apparatus 120 in the mobile body control system 101 in FIG. 4 in including an image acquisition unit 351, an image conversion unit 352 with semantic information, an image search unit 353, and a semantic matching unit 354 instead of the initial information acquisition unit 152, the map conversion unit 153, the LiDAR acquisition unit 154, the semantic point cloud conversion unit 155, and the semantic matching unit 156. Furthermore, an IMU 322 is connected to the information processing apparatus 320 in addition to a fisheye camera 321 corresponding to the sensor 21 described above. Instead of the fisheye camera 321, a wide-angle camera or a normal camera may be connected.

The image acquisition unit 351 corresponds to the sensor information acquisition unit 53 in FIG. 2, and acquires a camera image obtained by the fisheye camera 321 while the mobile body 20 is moving, and supplies the camera image to the image conversion unit 352 with semantic information and the odometry estimation unit 159.

The image conversion unit 352 with semantic information estimates semantic information for each pixel with respect to the camera image from the image acquisition unit 351. The camera image (image with semantic information) in which the semantic information is added to each pixel is supplied to the image search unit 353 and the semantic matching unit 354.

The image search unit 353 uses the image with semantic information from the image conversion unit 352 with semantic information as a search query, and searches for an image with the highest similarity from a plurality of virtual images with semantic information obtained from the information processing apparatus 310. The retrieved virtual image with semantic information is supplied to the semantic matching unit 354.

The semantic matching unit 354 corresponds to the matching unit 55 in FIG. 2, and performs matching between the image with semantic information from the image conversion unit 352 with semantic information and the virtual image with semantic information from the image search unit 353 for each attribute represented by the semantic information on the basis of the semantic information. The matching result between the images for each attribute is supplied to the reliability information transmission unit 157 and the self-position estimation unit 160.

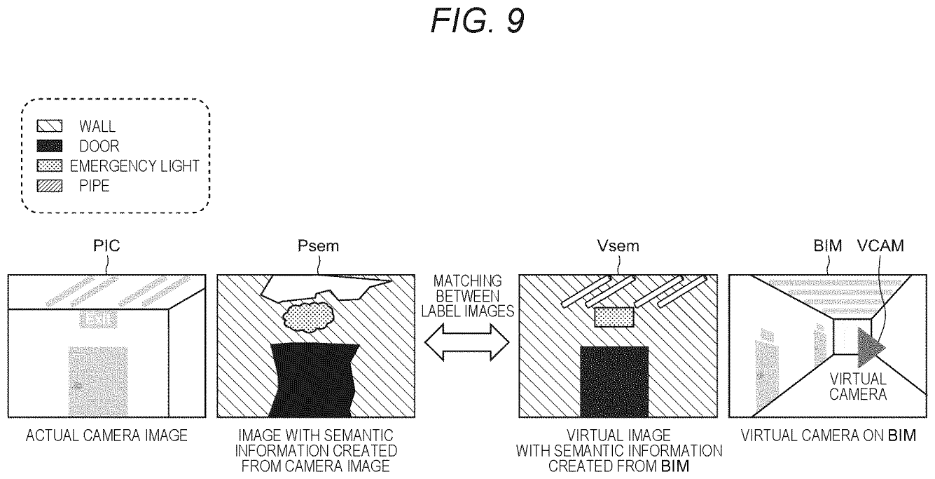

FIG. 9 is a diagram describing matching between images by the semantic matching unit 354.

As illustrated on the left side of FIG. 9, in the information processing apparatus 320, an image Psem with semantic information is created on the basis of an actual camera image PIC obtained by the fisheye camera 321. The image with semantic information Psem is a label image in which a label representing each object is given to a region corresponding to a wall, a door, an emergency light, a pipe, or the like.

On the other hand, as illustrated on the right side of FIG. 9, in the information processing apparatus 310, a virtual image Vsem with semantic information is created on the basis of the virtual image obtained by the virtual camera VCAM on the BIM model. The virtual image Vsem with semantic information is also a label image in which a label representing each object is given to an area corresponding to a wall, a door, an emergency light, a pipe, or the like.

Then, matching between label images (the image Psem with semantic information and the virtual image Vsem with semantic information) is performed. In this way, since the matching is performed only with the label (semantic information), matching excluding an object that does not exist on the BIM model can be performed.

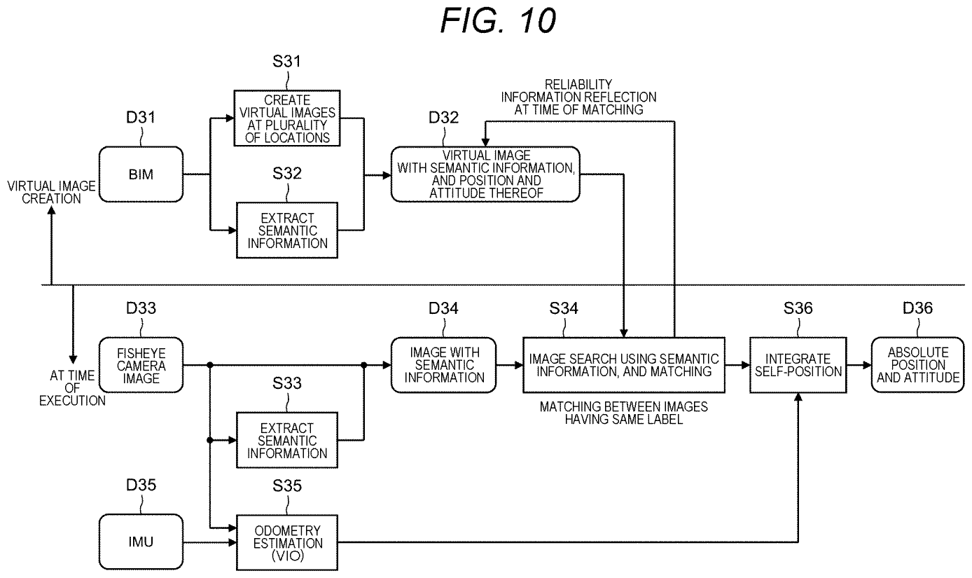

Next, a flow of self-position estimation processing in the mobile body control system 301 of the present embodiment will be described with reference to FIG. 10. Processing of FIG. 10 is divided into processing at the time of creating a virtual image (pre-map) and processing at the time of execution after the start of movement of the mobile body 20.

First, as processing at the time of virtual image creation, in step S31, the information processing apparatus 310 (virtual image creation unit 341) creates a plurality of virtual images at a plurality of locations on a BIM model D31 held in the BIM holding unit 141.

Subsequently, in step S32, the information processing apparatus 310 (semantic information extraction unit 143) extracts semantic information (for example, a label representing a window, a wall, a door, or the like.) from the BIM model D31 held in the BIM holding unit 141.

As a result, a virtual image with semantic information (and the position and attitude thereof) D32 in which each pixel holds semantic information is obtained as the pre-map.

Next, as processing at the time of execution, in step S33, the information processing apparatus 320 (the image conversion unit 352 with semantic information) extracts semantic information for each pixel from a fisheye camera image D33, thereby outputting an image D34 with semantic information in which each pixel holds semantic information.

In step S34, the information processing apparatus 320 (image search unit 353) uses the image D34 with semantic information as a search query to search for an image having the highest similarity from the virtual image D32 with semantic information. Then, the information processing apparatus 320 (semantic matching unit 156) performs matching between images having the same label using semantic information for the image D34 with semantic information and the searched virtual image. At this time, an animal body such as a person is excluded from the matching. As a matching result, a matching score is output for each label. The matching score for each label is reflected (weighted) in the pre-map (virtual image D32 with semantic information) as reliability information at the time of matching. Therefore, since matching using the weighted pre-map is performed, it is possible to absorb a difference between the pre-map and the actual environment.

In step S35, the information processing apparatus 320 (odometry estimation unit 159) estimates the position and attitude of the mobile body 20 for consecutive frames using VIO of an existing method or the like on the basis of the fisheye camera image D33 and IMU data D35.

In step S36, the information processing apparatus 320 (self-position estimation unit 160) estimates the self-position of the mobile body 20 on the basis of the matching score for each label. Furthermore, the information processing apparatus 320 (self-position estimation unit 160) integrates the estimated self-position of the mobile body 20 and the position and attitude of the mobile body 20 obtained by odometry estimation using an existing method such as a Kalman filter, thereby outputting an absolute position and attitude D36 of the mobile body 20 with respect to the BIM coordinate system. Therefore, even in a case where the mobile body 20 moves inside the building, the absolute position with respect to the environment can be acquired.

According to the above processing, since filtering of an animal body such as a person not included in the BIM model D31 is performed, it is possible to prevent a decrease in estimation accuracy of the self-position due to erroneous matching or occlusion. Specifically, by using semantic information, matching of only information specific to a building such as a wall, a door, and a window is performed, so that robust self-position estimation can be performed.

Furthermore, according to the above processing, since the difference between the pre-map and the actual environment is absorbed, robustness against the difference can be improved. Specifically, by reflecting the matching result as the reliability information in the pre-map and performing weighting in the estimation of the position and attitude, it is possible to improve the accuracy of the self-position estimation.

Note that, in the mobile body control system of the first to third embodiments described above, the processing at the time of creating the map (pre-map) and the processing at the time of execution after the start of movement of the mobile body 20 are executed separately in time. The present invention is not limited thereto, and processing at the time of map (pre-map) creation and processing at the time of execution may be executed in real time during movement of the mobile body 20.

### 6. Configuration Example of Hardware of Computer

The series of processing described above may be executed by hardware, or may be executed by software. In a case where the series of processing is performed by software, a program included in the software is installed from a program recording medium on a computer incorporated in dedicated hardware, a general-purpose personal computer, or the like.

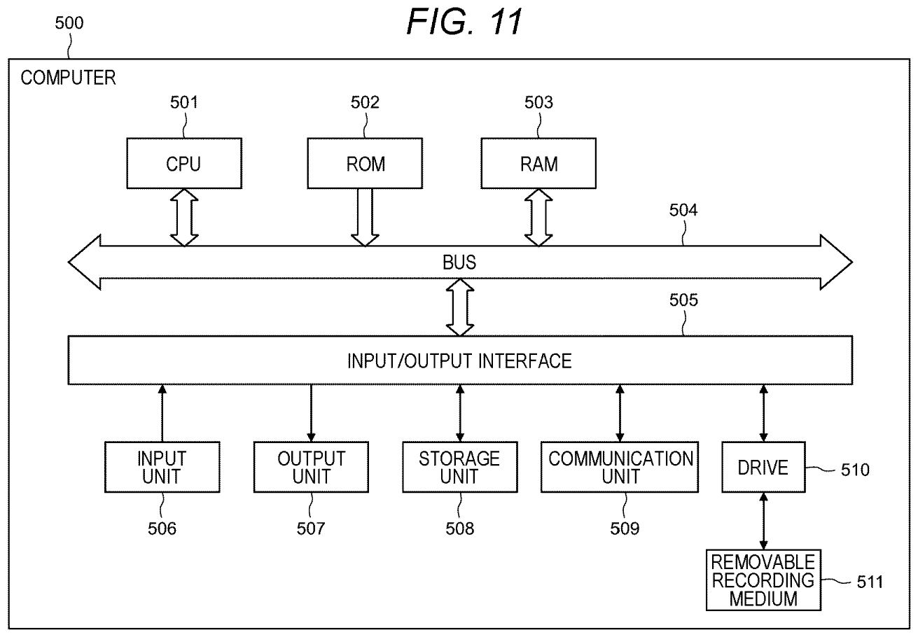

FIG. 11 is a block diagram illustrating a configuration example of hardware of a computer that executes the above-described series of processing by a program. A part of the functional blocks constituting the computer 10 and the mobile body 20 includes, for example, a PC having a configuration similar to a configuration illustrated in FIG. 11.

A central processing unit (CPU) 501, a read only memory (ROM) 502, and a random access memory (RAM) 503 are connected to each other by a bus 504.

An input/output interface 505 is further connected to the bus 504. An input unit 506 including a keyboard, a mouse, and the like, and an output unit 507 including a display, a speaker, and the like are connected to the input/output interface 505. Furthermore, a storage unit 508 including a hard disk, a nonvolatile memory, or the like, a communication unit 509 including a network interface or the like, and a drive 510 that drives a removable medium 511 are connected to the input/output interface 505.

In the computer configured as described above, for example, the CPU 501 loads a program stored in the storage unit 508 into the RAM 503 via the input/output interface 505 and the bus 504 and executes the program, whereby the series of processing described above is performed.

For example, the program executed by the CPU 501 is recorded in the removable medium 511, or provided via a wired or wireless transmission medium such as a local area network, the Internet, or digital broadcasting, and then installed in the storage unit 508.

The program executed by the computer may be a program in which the processing is performed in time series in the order described in the present description, or may be a program in which the processing is performed in parallel or at a necessary timing such as when a call is made.

Note that, here, a system means an assembly of a plurality of configuration elements (devices, modules (parts), and the like), and it does not matter whether or not all the configuration elements are located in the same housing. Therefore, a plurality of apparatuses housed in separate housings and connected to each other via a network and one apparatus in which a plurality of modules is housed in one housing are both systems.

The effects described in the present description are merely examples and are not limited, and other effects may also be provided.

The embodiment of the present disclosure is not limited to the embodiment described above, and various modifications can be made without departing from the gist of the present disclosure.

For example, the embodiment of the present disclosure can have a configuration of cloud computing in which one function is shared by a plurality of devices via a network and processing is performed in cooperation.

Furthermore, each step described in the flowchart described above may be performed by a single device, or may be performed by a plurality of devices in a shared manner.

Moreover, in a case where a single step includes a plurality of processing, the plurality of processing included in the single step can be performed by a single device or performed by a plurality of devices in a shared manner.

The effects described in the present specification are merely examples and are not limited, and other effects may be provided.

Moreover, the technology according to the present disclosure can have the following configurations.

(1)

An information processing method including:
acquiring, on the basis of structure information of an environment in which a mobile body moves, shape information representing a shape of the environment in the same format as sensor information;
extracting, from the structure information, semantic information representing a meaning of each region constituting the environment;
estimating the semantic information about the sensor information acquired by sensing the environment during movement of the mobile body; and
performing matching between the shape information and the sensor information for each attribute on the basis of the semantic information.
   (2)

The information processing method according to (1), in which
the matching between the shape information and the sensor information is performed for the attribute unique to a structure of the environment on the basis of the semantic information.
   (3)

The information processing method according to (2), in which
the shape information in the matching is weighted on the basis of a matching result, and
matching between the weighted shape information and the sensor information is performed.
   (4)

The information processing method according to any one of (1) to (3), in which
the structure information includes data in an industry foundation classes (IFC) format.
   (5)

The information processing method according to (4), in which
the structure information includes a building information modeling (BIM) model or a construction information modeling (CIM) model.
   (6)

The information processing method according to (1), in which
the structure information includes a floor map.
   (7)

The information processing method according to (1), in which
the structure information includes a high definition (HD) map.
   (8)

The information processing method according to any one of (1) to (7), in which
a self-position of the mobile body is estimated on the basis of a matching result.
   (9)

The information processing method according to (8), in which
an absolute position and attitude of the mobile body with respect to the environment are output on the basis of the self-position estimated on the basis of a matching result and a position and an attitude of the mobile body estimated by odometry.
   (10)

The information processing method according to any one of (1) to (9), in which
a point cloud is acquired as the shape information,
the point cloud is acquired as the sensor information, and
matching between the point clouds is performed.
   (11)

The information processing method according to (10), in which
matching between the point clouds is performed by iterative closest point (ICP).
   (12)

The information processing method according to (10) or (11), in which
the sensor information is acquired by LiDAR or a depth sensor.
   (13)

The information processing method according to any one of (1) to (9), in which
a point cloud is acquired as the shape information,
a plurality of camera images acquired as the sensor information is converted into the point cloud of a bird's-eye view, and
matching between the point clouds is performed.
   (14)

The information processing method according to (13), in which
matching between the point clouds is performed by iterative closest point (ICP).
   (15)

The information processing method according to (13) or (14), in which
the sensor information is acquired by a multi-camera.
   (16)

The information processing method according to any one of (1) to (9), wherein
a virtual image of a plurality of viewpoints is acquired as the shape information,
a camera image is acquired as the sensor information, and matching between the virtual image and the camera image is performed.
   (17)

The information processing method according to (16), in which
matching between the virtual image having a highest similarity to the camera image and the camera image is performed, the virtual image having been searched on the basis of the attribute.
   (18)

The information processing method according to (16) or (17), in which
the sensor information is acquired by a fisheye camera.
   (19)

A program for causing a computer to execute processing of:
acquiring, on the basis of structure information of an environment in which a mobile body moves, shape information representing a shape of the environment in the same format as sensor information;
extracting, from the structure information, semantic information representing a meaning of each region constituting the environment;
estimating the semantic information about the sensor information acquired by sensing the environment during movement of the mobile body; and
estimating an absolute position of the mobile body in the environment by performing matching between the shape information and the sensor information for each attribute on the basis of the semantic information.
   (20)

A mobile body control system including:
a shape information acquisition unit that, on the basis of structure information of an environment in which a mobile body moves, acquires shape information representing a shape of the environment in the same format as sensor information;
a semantic information extraction unit that, from the structure information, extracts semantic information representing a meaning of each region constituting the environment;
a semantic information estimation unit that estimates the semantic information about the sensor information acquired by sensing the environment during movement of the mobile body; and
a matching unit that performs matching between the shape information and the sensor information for each attribute on the basis of the semantic information.

### REFERENCE SIGNS LIST

1 Mobile body control system
10 Computer
20 Mobile body
21 Sensor
30 User terminal
41 Structure information holding unit
42 Shape information acquisition unit
43 Semantic information extraction unit
44 Map conversion unit
45 Map storage unit
46 Map holding unit
47 Communication unit
51 Communication unit
52 Map conversion unit
53 Sensor information acquisition unit
54 Semantic information estimation unit
55 Matching unit
56 Self-position estimation unit

What is claimed is:

1. An information processing method comprising:
acquiring, on a basis of structure information of an environment in which a mobile body moves, shape information representing a shape of the environment in a same format as sensor information;
extracting, from the structure information, semantic information representing a meaning of each region constituting the environment;
estimating the semantic information about the sensor information acquired by sensing the environment during movement of the mobile body; and
performing matching between the shape information and the sensor information for each attribute on a basis of the semantic information.

2. The information processing method according to claim 1, wherein
the matching between the shape information and the sensor information is performed for the attribute unique to a structure of the environment on a basis of the semantic information.

3. The information processing method according to claim 2, wherein
the shape information in the matching is weighted on a basis of a matching result, and
matching between the weighted shape information and the sensor information is performed.

4. The information processing method according to claim 1, wherein
the structure information includes data in an industry foundation classes (IFC) format.

5. The information processing method according to claim 4, wherein
the structure information includes a building information modeling (BIM) model or a construction information modeling (CIM) model.

6. The information processing method according to claim 1, wherein
the structure information includes a floor map.

7. The information processing method according to claim 1, wherein
the structure information includes a high definition (HD) map.

8. The information processing method according to claim 1, wherein
a self-position of the mobile body is estimated on a basis of a matching result.

9. The information processing method according to claim 8, wherein
an absolute position and attitude of the mobile body with respect to the environment are output on a basis of the self-position estimated on a basis of a matching result and a position and an attitude of the mobile body estimated by odometry.

10. The information processing method according to claim 1, wherein
a point cloud is acquired as the shape information,
the point cloud is acquired as the sensor information, and
matching between the point clouds is performed.

11. The information processing method according to claim 10, wherein
matching between the point clouds is performed by iterative closest point (ICP).

12. The information processing method according to claim 10, wherein
the sensor information is acquired by LiDAR or a depth sensor.

13. The information processing method according to claim 1, wherein
a point cloud is acquired as the shape information,
a plurality of camera images acquired as the sensor information is converted into the point cloud of a bird's-eye view, and
matching between the point clouds is performed.

14. The information processing method according to claim 13, wherein
matching between the point clouds is performed by iterative closest point (ICP).

15. The information processing method according to claim 13, wherein
the sensor information is acquired by a multi-camera.

16. The information processing method according to claim 1, wherein
a virtual image of a plurality of viewpoints is acquired as the shape information,
a camera image is acquired as the sensor information, and
matching between the virtual image and the camera image is performed.

17. The information processing method according to claim 16, wherein
matching between the virtual image having a highest similarity to the camera image and the camera image is performed, the virtual image having been searched on a basis of the attribute.

18. The information processing method according to claim 16, wherein
the sensor information is acquired by a fisheye camera.

19. A program for causing a computer to execute processing of:
acquiring, on a basis of structure information of an environment in which a mobile body moves, shape information representing a shape of the environment in a same format as sensor information;
extracting, from the structure information, semantic information representing a meaning of each region constituting the environment;
estimating the semantic information about the sensor information acquired by sensing the environment during movement of the mobile body; and
estimating an absolute position of the mobile body in the environment by performing matching between the shape information and the sensor information for each attribute on a basis of the semantic information.

20. A mobile body control system comprising:
a shape information acquisition unit that, on a basis of structure information of an environment in which a mobile body moves, acquires shape information representing a shape of the environment in a same format as sensor information;
a semantic information extraction unit that, from the structure information, extracts semantic information representing a meaning of each region constituting the environment;
a semantic information estimation unit that estimates the semantic information about the sensor information acquired by sensing the environment during movement of the mobile body; and
a matching unit that performs matching between the shape information and the sensor information for each attribute on a basis of the semantic information.
